(19) United States
(12) Patent Application Publication
(10) Pub. No.: US 2018/0106228 A1
(43) Pub. Date: Apr. 19, 2018

(54) GASKET FOR FUEL INJECTOR

(71) Applicants: Hyundai Motor Europe Technical Center GmbH, Russelsheim (DE); HYUNDAI MOTOR COMPANY, Seoul (KR); KIA MOTORS CORPORATION, Seoul (KR)

(72) Inventors: Stephan FITZNER, Russelsheim (DE); Stephan KOLK, Russelsheim (DE)

(21) Appl. No.: 15/369,385

(22) Filed: Dec. 5, 2016

(30) Foreign Application Priority Data
Oct. 18, 2016 (DE) 102016220395.9

(51) Int. Cl. F02M 61/16; F16J 15/08

(52) U.S. Cl. CPC F02M 61/166; F02M 2200/16; F16J 15/0893; F16J 15/0806

(57) ABSTRACT

A gasket for a fuel injector includes: an annular tube having an opening, a first surface, and a second surface, in which the second surface is disposed opposite to the first surface of the annular tube; and an inner portion and an outer portion connecting the first surface with the second surface. The inner portion and the outer portion include a flexible material and interact with a fluid filled within the annular tube via the opening of the annular tube.

### CROSS-REFERENCE(S) TO RELATED APPLICATION

This application claims the benefit of priori to German Patent Application No. 102016220395.9, filed on Oct. 18, 2016, which is incorporated herein by reference in its entirety.

### TECHNICAL FIELD

The present disclosure relates to a gasket for a fuel injector.

### BACKGROUND

Typically, washers made of copper are available with various predetermined thicknesses, for example, 1.0, 1.5 or 2.0 millimeters. That is, a vertical extent of the washer is predetermined and not adjustable or variable in their heights or thickness, respectively.

A fuel injection system having such washers has a major importance for the combustion within a combustion chamber of an engine. Within the combustion chamber of a vehicle, a correlation of an injector nozzle position, mainly holes, to a piston bowl layout is a main driver for a clean combustion.

The injector with its nozzle is mounted into an injector bore by using a washer arranged at a bottom end of the injector. A tip of the injector nozzle extends into the combustion chamber with a protrusion, in which the protrusion is predetermined by the thickness of the implemented washer. The washer has to seal the injector to the combustion chamber or cylinder head, respectively. Therefore, the washer has to be oil-tight and gastight.

As mentioned above, the conventional washers can have different thicknesses only. Consequently, the injector nozzle position can be adjusted to the piston bowl layout only once.

In other words, the washer thickness is calibrated for the corresponding combustion chamber of the engine, wherein the thickness of the washer cannot be varied but fixed. Therefore, the typical washer, which is used at maximum power and minimum power as well as for high speed and low-end speed, is not variable in its height. Thus, there is a problem that the injector position or injector nozzle position for every engine mode is fixed during operation of the combustion chamber.

Accordingly, a study to find the best-washer-thickness for different engine operation modes regarding emissions, especially particle emissions and fuel consumption, has been conducted.

Therefore, there is a need to develop a washer, such as a gasket, for the injector system to easily adapt variable positions of the injector and injector nozzle during operation of the fuel injection system.

Thus, there needs a gasket which can adapt itself to a range of injector positions so that the injector system can operate under its best mode and is simultaneously oil-tight and gastight, that is, the gasket comprises tightness and sealing properties for oil and gas in every position of the injector and the injector nozzle during operation. In other words, there is a need for a vertically adjustable gasket, wherein the gasket is able to be oil-tight and gastight, and the tip of the injector nozzle can be variably extended into the combustion chamber, i.e., the protrusion of the tip can be varied within a range of the vertically adjustable gasket.

### SUMMARY

According to an aspect of the present disclosure, a gasket for a fuel injector includes: an annular tube having an opening, a first surface, and a second surface, wherein the second surface is located opposite to the first surface of the annular tube; an inner portion and an outer portion connecting the first surface with the second surface. The inner portion and the outer portion comprise a flexible material and interact with a fluid filled within the annular tube via the opening of the annular tube.

The annular tube can comprise a hollow and can be ring-shaped. The first surface and the second surface can be even such that a mounting of corresponding components of the injector system can be easily realized in a gastight and oil-tight manner.

The inner portion and the outer portion may be side surfaces of the annular tube. The hollow which is formed within the annular tube may be surrounded by the first surface and the second surface as well as the inner portion and the outer portion. In other words, the opening of the annular tube may be arranged partially in the outer portion of the gasket. The opening may be provided to fill the hollow of the annular tube with a fluid.

The inner portion and the outer portion may include a flexible material and may interact with the fluid filled within the annular tube via the opening of the annular tube.

The annular tube may be fully filled with the fluid. In addition, the first and second surface may comprise the flexible material, in which a reversible deformation of the first and second surface can be prevented by the corresponding components of the fuel injector, for example, an injector and a cylinder head. The thickness of the flexible material can vary dependent on its function within the flexible gasket.

The annular tube may have an enclosed shape and the fluid may enter or exit the annular tube via the opening such that a pressure of the fluid is constant within the annular tube.

Due to the constant pressure of the fluid, the flexible material of the gasket returns to its initial shape after load during operation. That is, when there is a load the fluid, the annular tube via the opening and enters the annular tube via the opening after the load because the gasket tends to return in its initial shape after a load situation. The shape of the gasket is therefore reversible and the shape of the gasket depends on the position of the injector or injector nozzle, respectively.

The fluid may enter the annular tube at engine start.

The annular tube may be fully filled with the fluid at engine start in order to prevent or protect the gasket from breaking.

The annular tube may be connected with a constant pressure source via the opening.

The pressure of the fluid within the annular tube is constant during operation of the fuel injector. The constant fluid pressure can be easily managed by the constant pressure source. The constant pressure source may be a fluid pump.

The fluid may be oil.

Oil can be easily provided within a combustion engine of an automobile. Thus, the described gasket can be easily integrated in the fuel injector of the combustion engine. The oil can be homogeneously distributed within the annular tube at constant oil pressure.

The opening may be disposed in the outer portion of the gasket.

The outer portion of the gasket is disposed opposite to the inner portion of the gasket. Accordingly, the fluid pump or oil pump can be easily connected to the gasket.

The first surface may be partially mounted to an injector, and the second surface is partially mounted to a cylinder head.

In other words, the gasket can be easily arranged in a fuel injector due to the first surface and the second surface which are parallel to each other or have plane surfaces. Consequently, the gasket is oil-tight and gastight. That is, the gasket seals the combustion chamber for any adjusted injector position. The first surface and the second surface are in particular flush with the injector or the cylinder head, respectively.

The inner portion may comprise at least partially an injector nozzle guidance.

The injector nozzle guidance can additionally prevent or protect the gasket from breaking. Further, due to the injector nozzle guidance the injector nozzle or the tip of the injector nozzle can be easily inserted or plugged in the gasket.

The flexible material may be a spring steel.

A spring steel is a low-alloy, medium-carbon steel or high-carbon steel with very high yield strength. This allows the gasket to return to its initial or original shape despite significant deflection or twisting. The spring steel can also be hardened and tempered to meet requirements for specific applications.

The inner portion and the outer portion may partially reversibly deform in a perpendicular direction to a vertical extent of the gasket.

Here, the term vertical extent refers to a thickness of the gasket. The inner portion and the outer portion deform substantially in opposite directions, wherein a direction of the deformation of the inner portion can be predetermined by the shape of the injector nozzle.

A thickness of the inner portion may be partially different to a thickness of the outer portion.

By varying the thickness of the inner portion or the outer portion the deformation of the annular tube of the gasket can be easily modified. The thickness of the inner and the outer portions may be perpendicular to the vertical extent or the injector movement direction. On the other hand, when the inner and the outer portions have substantially the same thickness, the deformation of the inner portion and the outer portion during load can be simultaneously realized.

An exemplary embodiment of the present disclosure provides the flexible gasket for the fuel injector, wherein the gasket supports various positions of the fuel injector and is simultaneously oil-tight and gastight. Due to the fluid the gasket returns to its initial shape when the injector reaches its highest position during operation of the engine.

Therefore, an optimized injector position and an optimized injector nozzle position can be provided by the here described gasket. Consequently, based on the here described gasket an overall engine efficiency can be optimized which can in particular result in reduced fuel consumption as well as engine emissions.

In addition, the inner portion can additionally allow reducing the height of the gasket, wherein the injector nozzle guidance can limit the minimum height of the gasket. That is, by the injector nozzle guidance a minimum thickness of the here described gasket can be predefined.

The expected adjustment range is up to 2 millimeters. By varying the injector force or load, any position of the injector can be variably adjusted by the gasket, for example, 0.5 to 2.0 millimeter. The gasket can also remain in a certain position of the injector when the load of the injector is higher than the constant pressure of the fluid within the annular tube of the gasket.

### BRIEF DESCRIPTION OF THE FIGURES

FIG. 1 is a schematic view of a conventional washer.

FIG. 2 is a schematic view of a gasket according to an exemplary embodiment of the present disclosure.

FIGS. 3A and 3B are schematic cross-sectional views of the gasket in its initial shape and under load according to an exemplary embodiment of the present disclosure.

FIG. 4 is a schematic cross-sectional view according to an exemplary embodiment of the present disclosure.

FIG. 5 is a schematic cross sectional view of a fuel injection system with a gasket according to an exemplary embodiment of the present disclosure.

Unless indicated otherwise, like reference numbers to the figures indicate like elements.

### DETAILED DESCRIPTION OF THE EMBODIMENTS

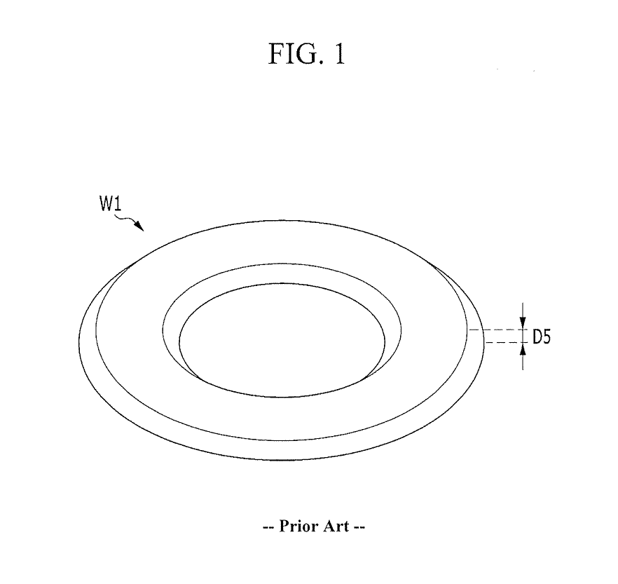

FIG. 1 illustrates a schematic view of a conventional washer.

Referring to FIG. 1, a conventional washer W1 has a predetermined thickness or vertical extent D5. The washer can be available with a thickness of 1.0, 1.5 or 2.0 millimeter. The thickness of the washer W1 is not adjustable or variable with respect to an injector position. That is, the protrusion of an injection nozzle or the protrusion of a tip of the injector nozzle is predefined. Consequently, a combustion engine having the washer W1 cannot be efficiently driven in terms of the position of the injector nozzle since the washer has a fixed vertical extent or thickness D5. The washer W1 is typically made of copper.

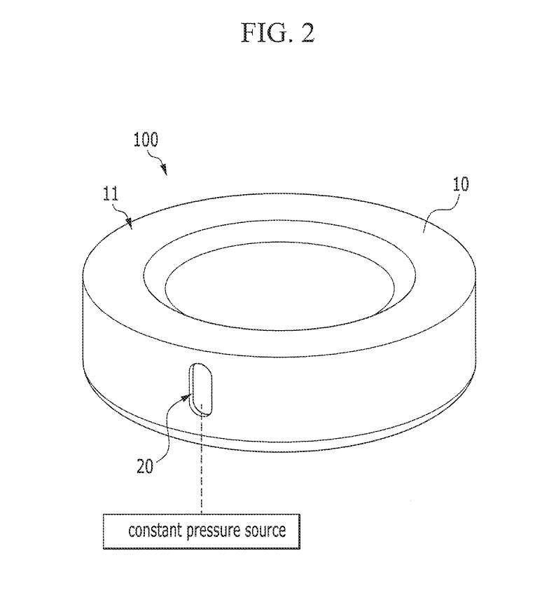

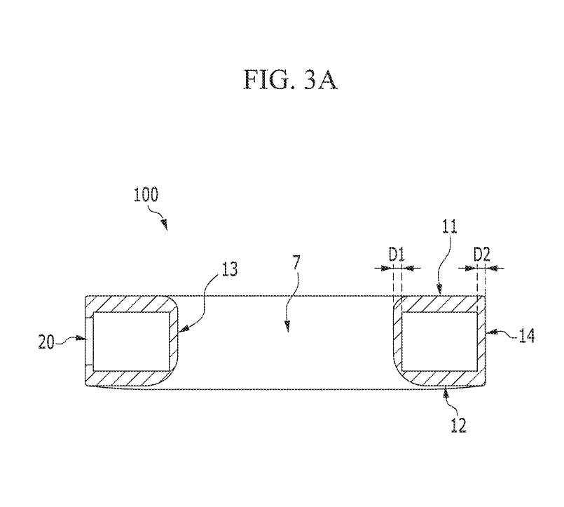

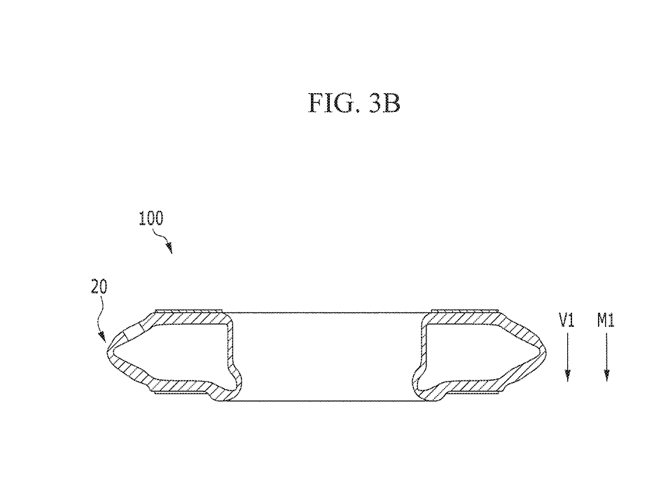

FIG. 2 illustrates a schematic view of a gasket according to an exemplary embodiment of the present disclosure. FIGS. 3A and 3B illustrate schematic cross-sectional views of the gasket in its initial shape and under load according to an exemplary embodiment of the invention.

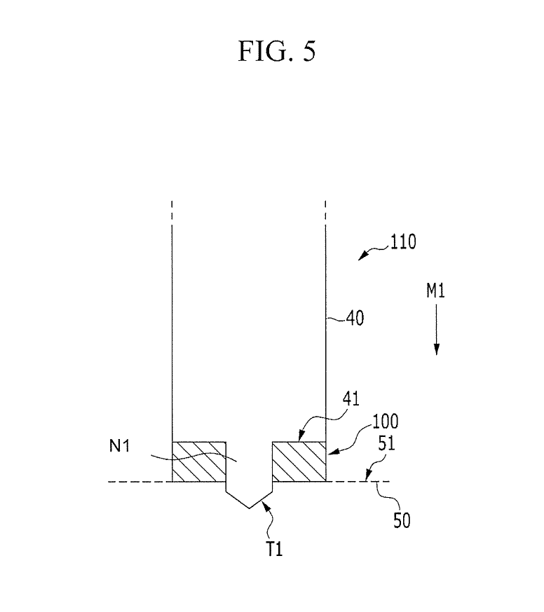

Referring to FIGS. 2-3B, a gasket 100 for a fuel injector 110 (see FIG. 5) comprises an annular tube 10 with an opening 20 and a first surface 11 and a second surface 12. The second surface 12 is located opposite to the first surface 11 of the annular tube 10. The annular tube 10 may be hollow and may have a ring-shape. The first surface 11 and the second surface 12 may be parallel to each other, such that mounting of corresponding components of the injector system 110 can be easily realized in oil-tight manner.

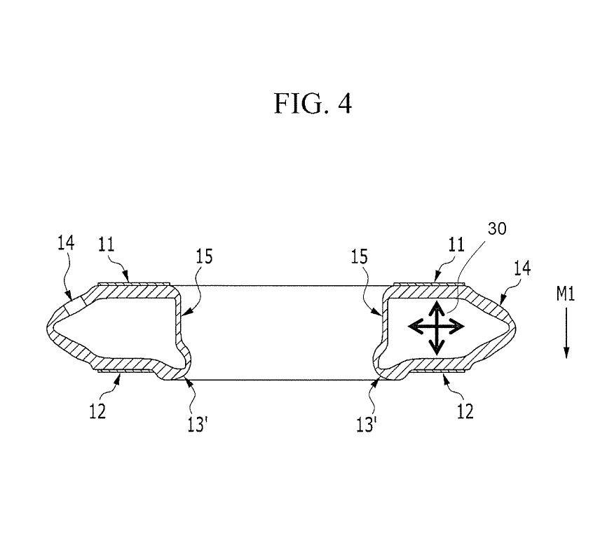

The gasket 100 further comprises an inner portion 13 and an outer portion 14, wherein the inner portion 13 and the outer portion 14 of the gasket 100 connect the first surface 11 with the second surface 12. The inner portion 13 and the outer portion 14 include a flexible material 7 and interact with a fluid 30 (refer to FIG. 4) filled within the annular tube 10 via the opening 20 of the annular tube 10.

The opening 20 may be connected to a constant pressure source (not shown), such as a fluid pump or an oil pump. The constant pressure source allows the pressure of the fluid 30 within the annular tube 10 to be constant during operation of the fuel injector 110. The constant fluid pressure can be easily managed by the constant pressure source, for example, fluid pump. In other words, the fluid 30 is homogeneously distributed within the gasket 100. In an exemplary embodiment of the present disclosure, the fluid 30 may be oil. The opening 20 is arranged on the outer portion 14 of the gasket 100. The gasket may be made of spring steel, e.g. X7CrNiAl177K+A (DIN 17224) or 55Cr3 (DIN 17221). Referring to FIG. 3A, which illustrates the gasket 100 in its initial state, the initial state can be obtained at engine start since the fluid 30, for example, oil, enters the annular tube 10 of the gasket 100. The annular tube 10 may be fully filled with the fluid at engine start in order to prevent or protect the gasket from breaking.

FIG. 3B illustrates a case in which a gasket is under load according to an exemplary embodiment of the present disclosure. As can be seen in FIG. 3B, the inner portion 13 and the outer portion 14 are at least partially reversibly deformed oblique to a vertical extent V1 of the gasket 100. The vertical extent V1 of the gasket 100 is parallel to an injector movement direction M1. The inner portion 13 and the outer portion 14 deform substantially in opposite directions. A direction of the deformation of the inner portion 13 can be predetermined by the shape of the injector nozzle N1. FIG. 4 illustrates a schematic cross-sectional view according to an exemplary embodiment of the present disclosure.

Referring to FIG. 4 an injector nozzle guidance 15 may be arranged above a reversibly deformable region (13′) of the inner portion 13. Here, numeral reference 30 indicates homogenous distribution of the oil. Under the constant oil pressure level, a constant counter pressure with respect to a movement of an injector 40 can be maintained. The first surface 11 may be at least partially mounted on an injector 40 of the fuel injector 110 and the second surface 12 may be at least partially mounted on a cylinder head 50 of the fuel injector 110. A thickness D1 of the inner portion 13 may be at least partially different to a thickness D2 of the outer portion 14 (refer to FIG. 3A). By varying the thickness D1 or D2, the deformation of the annular tube 10 of the gasket 100 can be easily modified. The thickness D1 and D2 may be perpendicular to the vertical extent V1 or the injector movement direction M1. On the other hand, when the inner and the outer portions 13, 14 have substantially the same thickness D1, D2, the deformation of the inner portion 13 and the outer portion 14 during load can be simultaneously realized

FIG. 5 illustrates a schematic cross-sectional view of a fuel injection system with a gasket according to an exemplary embodiment of the present disclosure.

FIG. 5 illustrates the injector 40 having an injector surface 41 and the cylinder head 50 having a cylinder head surface 51. The gasket 100 may be disposed between the injector surface 41 and the cylinder head surface 51, wherein the injector surface 41 and cylinder head surface 51 face each other. The injector nozzle N1 or the tip of the injector nozzle T1 is disposed or inserted in the gasket 10. The injector nozzle N1 may be in contact with the injector nozzle guidance 15.

Although the here afore-mentioned gasket has been described in connection to vehicles, accordingly. For a person skilled in the art it is clearly and unambiguously understood that the here described gasket can be applied to various object which comprises combustion engines based on injector system.

1. A gasket for a fuel injector, comprising:
an annular tube having an opening, a first surface, and a second surface, the second surface of the annular tube disposed opposite to the first surface of the annular tube; and
an inner portion and an outer portion, each of which connecting the first surface with the second surface,
wherein the inner portion and the outer portion include a flexible material and interact with a fluid filled within the annular tube via the opening of the annular tube,
wherein the first surface is partially mounted on the fuel injector and the second surface is partially mounted on a cylinder head,
wherein the inner portion comprises at least partially a fuel injector nozzle guidance, and
wherein the first and second surfaces are resilient by the fluid filled within the annular tube.

2. The gasket according to claim 1, wherein the annular tube has an enclosed shape and the fluid enters or exits the annular tube via the opening such that a pressure of the fluid is constant inside the annular tube.

3. The gasket according to claim 1, wherein the fluid enters the annular tube at engine start.

4. The gasket according to claim 2, wherein the fluid enters the annular tube at engine start.

5. The gasket according to claim 1, wherein the annular tube is connected with a constant pressure source via the opening.

6. The gasket according to claim 1, wherein the fluid is oil.

7. The gasket according to claim 1, wherein the opening is formed on the outer portion of the gasket.

8.-9. (canceled)

10. The gasket according to claim 1, wherein the flexible material is a spring steel.

11. The gasket according to claim 1, wherein the inner portion and the outer portion partially reversibly deform in a perpendicular direction to a vertical extent of the gasket.

12. The gasket according claim 1, wherein a thickness of the inner portion is different from a thickness of the outer portion.

13. The gasket according claim 11, wherein the vertical extent of the gasket is a thickness of the gasket.
